(19) United States
(12) Patent Application Publication
(10) Pub. No.: US 2024/0236748 A1
(43) Pub. Date: Jul. 11, 2024

(54) REPORTING REFERENCE SIGNAL RECEIVED POWER FOR MULTIPLE CELLS

(71) Applicant: LENOVO (BEIJING) LIMITED, Beijing (CN)

(72) Inventors: Chenxi Zhu, Fairfax, VA (US); Bingchao Liu, Beijing (CN)

(21) Appl. No.: 18/560,229

(22) PCT Filed: May 11, 2021
(86) PCT No.: PCT/CN2021/093089

§ 371 Date: Nov. 10, 2023

(51) Int. Cl. H04W 24/10; H04L 5/00

(52) U.S. Cl. CPC H04W 24/10; H04L 5/0048

(57) ABSTRACT

Apparatuses, methods, and systems are disclosed for reporting reference signal received power for multiple cells. One method includes receiving a channel state information report configuration message indicating resources for channel measurement. The resources include downlink reference signal resources from a serving cell and at least one non-serving cell, and the resources are configured for first layer reference signal received power measurement. The method includes receiving transmission power information for synchronization signal blocks from the serving cell and the at least one non-serving cell. The method includes conducting first layer reference signal received power measurements for the resources. The method includes adjusting the first layer reference signal received power measurements for reference signals transmitted from the at least one non-serving cell based on the transmission power information. The method includes reporting multiple first layer reference signal received power measurements.

### FIELD

The subject matter disclosed herein relates generally to wireless communications and more particularly relates to reporting reference signal received power for multiple cells.

### BACKGROUND

In certain wireless communications networks, multiple cells may make transmissions. Measurements of the transmissions from the multiple cells may be made.

### BRIEF SUMMARY

Methods for reporting reference signal received power for multiple cells are disclosed. Apparatuses and systems also perform the functions of the methods. In one embodiment, the method includes receiving, at a user equipment, a channel state information report configuration message indicating a plurality of resources for channel measurement. The plurality of resources for channel measurement includes downlink reference signal resources from a serving cell and at least one non-serving cell, and the plurality of resources for channel measurement are configured for first layer reference signal received power measurement. In various embodiments, the method includes receiving transmission power information for synchronization signal blocks from the serving cell and the at least one non-serving cell. In some embodiments, the method includes conducting first layer reference signal received power measurements for the plurality of resources. In certain embodiments, the method includes adjusting the first layer reference signal received power measurements for reference signals transmitted from the at least one non-serving cell based on the transmission power information. In various embodiments, the method includes reporting a plurality of first layer reference signal received power measurements. The plurality of first layer reference signal received power measurements includes measurements from the serving cell and the at least one non-serving cell, the plurality of first layer reference signal received power measurements are reported in the same channel state information report, and the channel state information report includes a cell identification and a reference signal index corresponding to each reference signal received power measurement of the plurality of first layer reference signal received power measurements.

An apparatus for reporting reference signal received power for multiple cells, in one embodiment, includes a user equipment. In certain embodiments, the apparatus includes a receiver that: receives a channel state information report configuration message indicating a plurality of resources for channel measurement, wherein the plurality of resources for channel measurement includes downlink reference signal resources from a serving cell and at least one non-serving cell, and the plurality of resources for channel measurement are configured for first layer reference signal received power measurement; and receives transmission power information for synchronization signal blocks from the serving cell and the at least one non-serving cell. In some embodiments, the apparatus includes a processor that: conducts first layer reference signal received power measurements for the plurality of resources; and adjusts the first layer reference signal received power measurements for reference signals transmitted from the at least one non-serving cell based on the transmission power information. In various embodiments, the apparatus includes a transmitter that reports a plurality of first layer reference signal received power measurements. The plurality of first layer reference signal received power measurements includes measurements from the serving cell and the at least one non-serving cell, the plurality of first layer reference signal received power measurements are reported in the same channel state information report, and the channel state information report includes a cell identification and a reference signal index corresponding to each reference signal received power measurement of the plurality of first layer reference signal received power measurements.

In various embodiments, a method for reporting reference signal received power for multiple cells includes transmitting, from a base station, a channel state information report configuration message indicating a plurality of resources for channel measurement. The plurality of resources for channel measurement includes downlink reference signal resources from a serving cell and at least one non-serving cell, and the plurality of resources for channel measurement are configured for first layer reference signal received power measurement. In some embodiments, the method includes transmitting transmission power information for synchronization signal blocks from the serving cell and the at least one non-serving cell. In certain embodiments, the method includes receiving a report including a plurality of first layer reference signal received power measurements. The plurality of first layer reference signal received power measurements includes measurements from the serving cell and the at least one non-serving cell, the plurality of first layer reference signal received power measurements are received in the same channel state information report, and the channel state information report includes a cell identification and a reference signal index corresponding to each reference signal received power measurement of the plurality of first layer reference signal received power measurements.

In some embodiments, an apparatus for reporting reference signal received power for multiple cells includes a base station. In certain embodiments, the apparatus includes a transmitter that: transmits a channel state information report configuration message indicating a plurality of resources for channel measurement, wherein the plurality of resources for channel measurement includes downlink reference signal resources from a serving cell and at least one non-serving cell, and the plurality of resources for channel measurement are configured for first layer reference signal received power measurement; and transmits transmission power information for synchronization signal blocks from the serving cell and the at least one non-serving cell. In various embodiments, the apparatus includes a receiver that receives a report including a plurality of first layer reference signal received power measurements, wherein the plurality of first layer reference signal received power measurements includes measurements from the serving cell and the at least one non-serving cell, the plurality of first layer reference signal received power measurements are received in the same channel state information report, and the channel state information report includes a cell identification and a reference signal index corresponding to each reference signal received power measurement of the plurality of first layer reference signal received power measurements.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for reporting reference signal received power for multiple cells;

FIG. 2 is a schematic block diagram illustrating one embodiment of an apparatus that may be used for reporting reference signal received power for multiple cells;

FIG. 3 is a schematic block diagram illustrating another embodiment of an apparatus that may be used for reporting reference signal received power for multiple cells;

FIG. 4 is a block diagram illustrating one embodiment of a ServingCellConfigCommon information element;

FIG. 5 is a block diagram illustrating one embodiment of a ServingCellConfigCommonSIB information element;

FIG. 6 is a schematic flow chart diagram illustrating one embodiment of a method for reporting reference signal received power for multiple cells; and

FIG. 7 is a schematic flow chart diagram illustrating another embodiment of a method for reporting reference signal received power for multiple cells.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment.” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

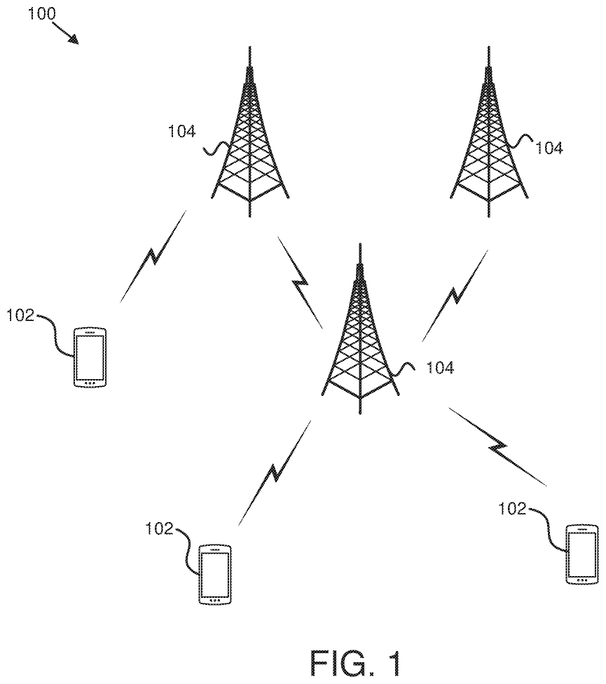

FIG. 1 depicts an embodiment of a wireless communication system 100 for reporting reference signal received power for multiple cells. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via uplink (“UL”) communication signals and/or the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNodeB (“gNB”), a Home Node-B, a RAN, a relay node, a device, a network device, an integrated and access backhaul (“IAB”) node, a donor IAB node, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 5G or NG (Next Generation) standard of the third generation partnership program (“3GPP”) protocol, wherein the network unit 104 transmits using NG RAN technology. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit downlink (“DL”) communication signals to serve the remote units 102 in the time, frequency, and/or spatial domain.

In various embodiments, a remote unit 102 may receive, at a user equipment, a channel state information report configuration message indicating a plurality of resources for channel measurement. The plurality of resources for channel measurement includes downlink reference signal resources from a serving cell and at least one non-serving cell, and the plurality of resources for channel measurement are configured for first layer reference signal received power measurement. In various embodiments, the remote unit 102 may receive transmission power information for synchronization signal blocks from the serving cell and the at least one non-serving cell. In some embodiments, the remote unit 102 may conduct first layer reference signal received power measurements for the plurality of resources. In certain embodiments, the remote unit 102 may adjust the first layer reference signal received power measurements for reference signals transmitted from the at least one non-serving cell based on the transmission power information. In various embodiments, the remote unit 102 may report a plurality of first layer reference signal received power measurements. The plurality of first layer reference signal received power measurements includes measurements from the serving cell and the at least one non-serving cell, the plurality of first layer reference signal received power measurements are reported in the same channel state information report, and the channel state information report includes a cell identification and a reference signal index corresponding to each reference signal received power measurement of the plurality of first layer reference signal received power measurements. Accordingly, a remote unit 102 may be used for reporting reference signal received power for multiple cells.

In some embodiments, a network unit 104 may transmit, from a base station, a channel state information report configuration message indicating a plurality of resources for channel measurement. The plurality of resources for channel measurement includes downlink reference signal resources from a serving cell and at least one non-serving cell, and the plurality of resources for channel measurement are configured for first layer reference signal received power measurement. In some embodiments, the network unit 104 may transmit transmission power information for synchronization signal blocks from the serving cell and the at least one non-serving cell. In certain embodiments, the network unit 104 may receive a report including a plurality of first layer reference signal received power measurements. The plurality of first layer reference signal received power measurements includes measurements from the serving cell and the at least one non-serving cell, the plurality of first layer reference signal received power measurements are received in the same channel state information report, and the channel state information report includes a cell identification and a reference signal index corresponding to each reference signal received power measurement of the plurality of first layer reference signal received power measurements. Accordingly, a network unit 104 may be used for reporting reference signal received power for multiple cells.

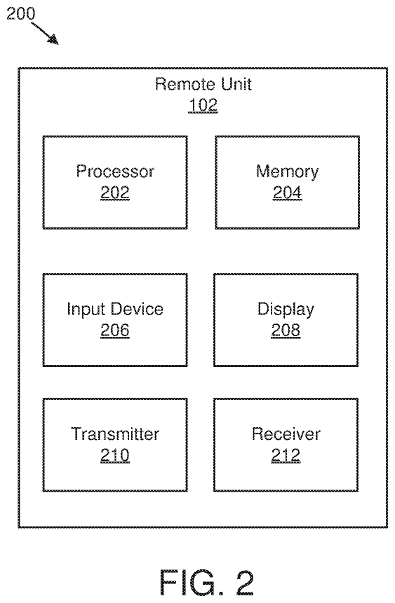

FIG. 2 depicts one embodiment of an apparatus 200 that may be used for reporting reference signal received power for multiple cells. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”) display, an LED display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In various embodiments, the receiver 212 may: receive a channel state information report configuration message indicating a plurality of resources for channel measurement, wherein the plurality of resources for channel measurement includes downlink reference signal resources from a serving cell and at least one non-serving cell, and the plurality of resources for channel measurement are configured for first layer reference signal received power measurement; and receive transmission power information for synchronization signal blocks from the serving cell and the at least one non-serving cell. In some embodiments, the processor 202 may: conduct first layer reference signal received power measurements for the plurality of resources; and adjust the first layer reference signal received power measurements for reference signals transmitted from the at least one non-serving cell based on the transmission power information. In various embodiments, the transmitter 210 may report a plurality of first layer reference signal received power measurements. The plurality of first layer reference signal received power measurements includes measurements from the serving cell and the at least one non-serving cell, the plurality of first layer reference signal received power measurements are reported in the same channel state information report, and the channel state information report includes a cell identification and a reference signal index corresponding to each reference signal received power measurement of the plurality of first layer reference signal received power measurements.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

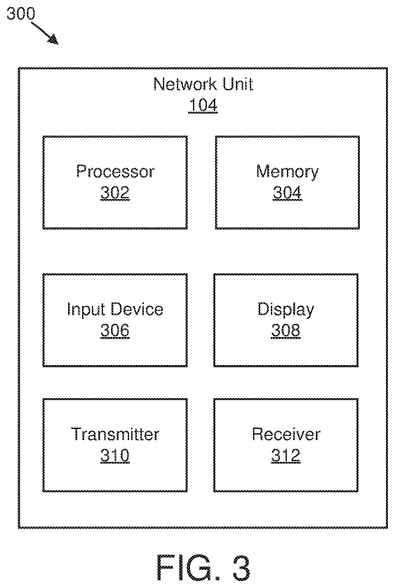

FIG. 3 depicts another embodiment of an apparatus 300 that may be used for reporting reference signal received power for multiple cells. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In various embodiments, the transmitter 310 may: transmit a channel state information report configuration message indicating a plurality of resources for channel measurement, wherein the plurality of resources for channel measurement includes downlink reference signal resources from a serving cell and at least one non-serving cell, and the plurality of resources for channel measurement are configured for first layer reference signal received power measurement; and transmit transmission power information for synchronization signal blocks from the serving cell and the at least one non-serving cell. In various embodiments, the receiver 312 may receive a report including a plurality of first layer reference signal received power measurements, wherein the plurality of first layer reference signal received power measurements includes measurements from the serving cell and the at least one non-serving cell, the plurality of first layer reference signal received power measurements are received in the same channel state information report, and the channel state information report includes a cell identification and a reference signal index corresponding to each reference signal received power measurement of the plurality of first layer reference signal received power measurements.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

In certain embodiments, there may be layer 1 (“L1”) reference signal received power (“RSRP”) (“L1-RSRP”) (e.g., first layer RSRP) reporting with reference signals (“RSs”) from both of a serving cell and at least one non-serving cell. When the reference signal is SSB, the L1-RSRP is SS-RSRP. When the reference is signal is CSI-RS, the L1-RSRP is CSI-RSRP. As may be appreciated, because different serving cells may transmit their synchronization signal blocks (“SSBs”) with different power levels, the received power level from different cells may not reflect a different path loss for the cells. In such embodiments, this may lead to a user equipment (“UE”) not reporting the L1-RSRP of some RSs (e.g., SSBs, channel state information reference signals (“CSI-RSs”)) from a cell (e.g., all RSs from a cell) because of a lower transmission power of the cell. Moreover, if a UE sends only the largest L1-RSRP (e.g., nrofReportedRS L1-RSRP) measurements to a gNB in a channel state information (“CSI”) report, the gNB may miss some or all of the RSs from a cell due to the cell's low transmission power. This may lead to an erroneous handover decision by the gNB. As may be appreciated, this may happen if one of the cells is a macro cell with high transmission power, and another cell is a micro or femto cell with low transmission power.

In some embodiments, a UE may report more than 1 L1-RSRP value if a corresponding parameter (e.g., groupBasedBeamReporting) is set to enabled or a certain parameter (e.g., nrofReportedRS) is more than one. The measured RSRP values may be reported in a differential form (e.g., except the largest value).

In certain embodiments, a report quantity configuration may include the following: 1) a UE may be configured with a CSI-ReportConfig with a higher layer parameter reportQuantity set to either ‘none’, ‘cri-RI-PMI-CQI’, ‘cri-RI-i1’, ‘cri-RI-i1-CQI’, ‘cri-RI-CQI’, ‘cri-RSRP’, ‘cri-SINR’, ‘ssb-Index-RSRP’, ‘ssb-Index-SINR’, or ‘cri-RI-L1-PMI-CQI’; and 2) if the UE is configured with a CSI-ReportConfig with the higher layer parameter reportQuantity set to ‘cri-RSRP’ or ‘ssb-Index-RSRP’, a) if the UE is configured with the higher layer parameter groupBasedBeamReporting set to ‘disabled’, the UE is not required to update measurements for more than 64 CSI-RS and/or SSB resources, and the UE may report in a single report nrofReportedRS (e.g., higher layer configured) different CRI or synchronization signal block rank index (“SSBRI”) for each report setting; or b) if the UE is configured with the higher layer parameter groupBasedBeamReporting set to ‘enabled’, the UE may not be required to update measurements for more than 64 CSI-RS and/or SSB resources, and the UE shall report in a single reporting instance of two different CRI or SSBRI for each report setting, where CSI-RS and/or SSB resources may be received simultaneously by the UE either with a single spatial domain receive filter, or with multiple simultaneous spatial domain receive filters.

In various embodiments, for L1-RSRP reporting, there may be an L1-RSRP computation in which: 1) a UE may be configured with CSI-RS resources, synchronization signal and/or physical broadcast channel (“SS/PBCH”) block resources, or both CSI-RS and SS/PBCH block resources, when resource-wise quasi co-located with ‘type C’ and ‘typeD’; and/or 2) the UE may be configured with CSI-RS resource setting up to 16 CSI-RS resource sets having up to 64 resources within each set—the total number of different CSI-RS resources over all resource sets may be no more than 128.

In some embodiments, for L1-RSRP reporting, if a higher layer parameter nrofReportedRS in CSI-ReportConfig is configured to be one, the reported L1-RSRP value may be defined by a 7-bit value in the range [−140, −44] dBm with 1 dB step size, if the higher layer parameter nrofReportedRS is configured to be larger than one, or if the higher layer parameter groupBasedBeamReporting is configured as ‘enabled’, the UE may use differential L1-RSRP based reporting, where the largest measured value of L1-RSRP is quantized to a 7-bit value in the range [−140, −44] dBm with 1 dB step size, and the differential L1-RSRP is quantized to a 4-bit value. The differential L1-RSRP value is computed with 2 dB step size with a reference to the largest measured L1-RSRP value which is part of the same L1-RSRP reporting instance. There may be a mapping between the reported L1-RSRP value and the measured quantity.

In certain embodiments, if a UE is not configured with higher layer parameter timeRestrictionForChannelMeasurements in CSI-ReportConfig, the UE may derive channel measurements for computing L1-RSRP value reported in an uplink slot n based on only SS and/or physical broadcast channel (“PBCH”) or non-zero power (“NZP”) CSI-RS, no later than the CSI reference resource associated with the CSI resource setting.

In various embodiments, if a UE is configured with higher layer parameter timeRestrictionForChannelMeasurements in CSI-ReportConfig, the UE may derive the channel measurements for computing L1-RSRP reported in uplink slot n based on only the most recent, no later than the CSI reference resource, occasion of SS and/or PBCH or NZP CSI-RS associated with the CSI resource setting.

In some embodiments, a transmission power of a SSB for a serving cell may be sent to a UE from a gNB in RRC signaling in a parameter ss-PBCH-blockpower, such as in a ServingCellConfigCommon information element (“IE”).

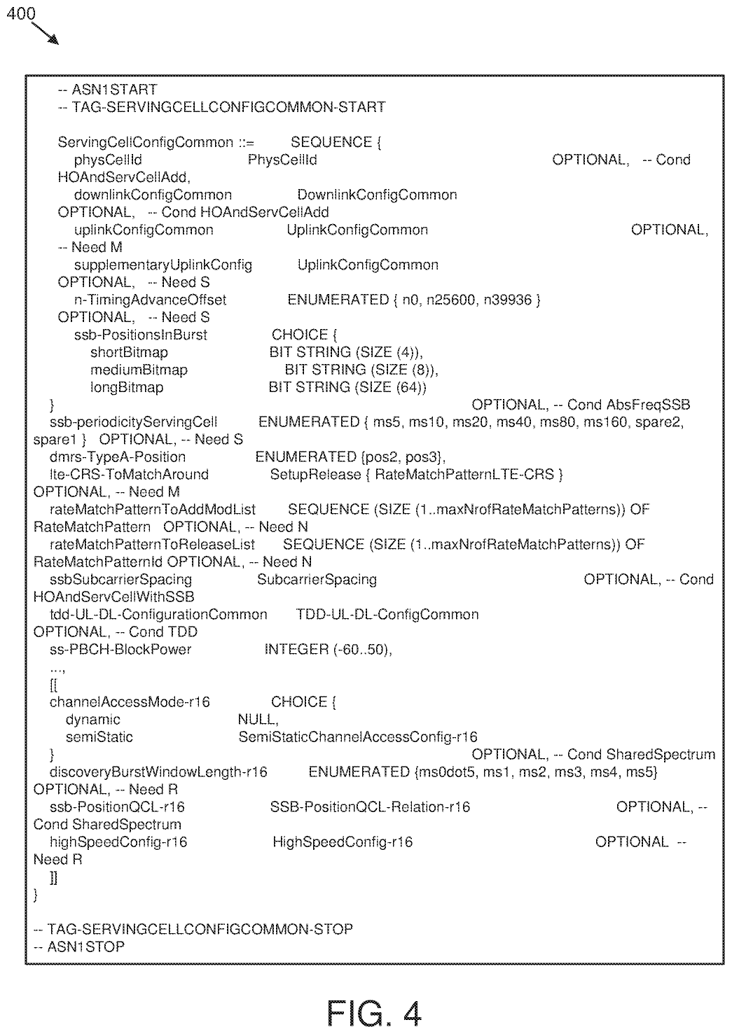

In certain embodiments, the ServingCellConfigCommon IE is used to configure cell specific parameters of a UE's serving cell. In such embodiments, the ServingCellConfigCommon IE contains parameters that a UE may typically acquire from SSBs, master information blocks (“MIBs”), or SIBs if accessing the cell from an idle (e.g., IDLE) mode. With the ServingCellConfigCommon IE, a network may provide information in dedicated signaling if configuring a UE with a secondary cells (“SCells”) or with an additional cell group (e.g., secondary cell group (“SCG”)). In such embodiments, the network may provide information for SpCells (e.g., master cell group (“MCG”) and secondary cell group (“SCG”)) upon reconfiguration with synchronization. FIG. 4 is a block diagram illustrating one embodiment of a ServingCellConfigCommon information element 400.

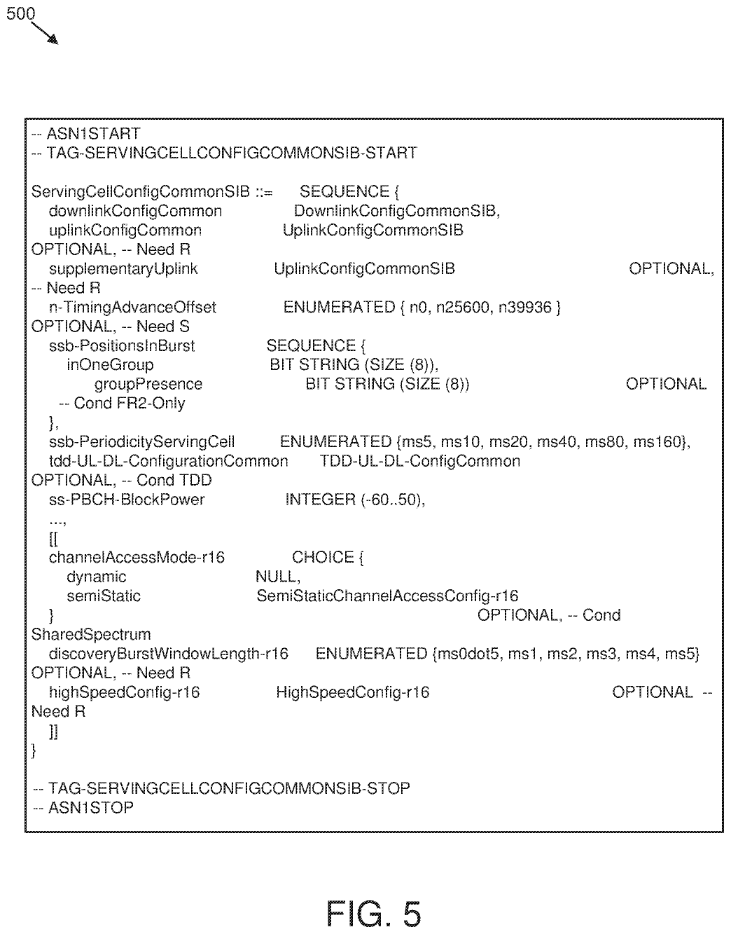

In various embodiments, a ServingCellConfigCommonSIB IE may be used to configure cell specific parameters of a UE's serving cell in system information block 1 (“SIB1”). FIG. 5 is a block diagram illustrating one embodiment of a ServingCellConfigCommonSIB information element 500.

In some embodiments, a UE receives information about a transmitter or transmission (“TX”) power of a serving cell as part of radio resource control (“RRC”) parameters. In certain embodiments, such as for CSI-RS, a UE may derive TX power from a power offset between a SSB and a CSI-RS (e.g., powerControlOffsetSS). In various embodiments, from a measurement of L1-RSRP of an SSB or a CSI-RS, a UE may compute a pathloss to the UE's serving cell, and only include an SSB (e.g., nrofReportedRS SSB) with a strongest L1-RSRP (or separately CSI-RS) in a CSI report. Because these RSs (e.g., SSB and CSI-RS) all share the same TX power, they also correspond to the SSBs with the strongest links (e.g., least pathloss) to the serving cell.

In certain embodiments, to support L1 and/or layer 2 (“L2”) inter-cell mobility, a UE may report multiple L1-RSRPs from both of a serving cell and at least one non-serving cell in the same CSI report. As may be appreciated, a purpose of reporting these L1-RSRPs to a gNB may be to enable the gNB to decide whether the UE should be handed over to a non-serving cell based on a path-loss between the UE and the serving and the at least one non-serving cell. In various embodiments, to provide path-loss information between a UE and a serving cell and at least one non-serving cell, without dropping RSs unnecessarily due to weak L1-RSRP caused by low transmission power, a UE may scale a L1-RSRP measurement of RSs from non-serving cells with a difference between a TX power of the SSB of the serving cell (e.g., ss-PBCH-Blockpowerₛ) and a TX power of the SSB of the non-serving cell (e.g., ss-PBCH-Blockpowerₙₛ). The adjusted L1-RSRP of the SSB from the non-serving cell (e.g., adjusted by scaling) may be a received L1-RSRP of the SSB as if the non-serving cell was transmitting with the same TX power as the serving cell. By adjusting the L1-RSRP of the SSB, a discrepancy caused by different TX powers between a serving cell and a non-serving cell may be resolved. As may be appreciated, determining an adjusted L1-RSRP may require SSB transmission power of a non-serving cell (e.g., ss-PBCH-Blockpower) to be sent to a UE together with a physical cell identifier (“ID”) (“PCI”) (e.g., as part of information of the non-serving cell).

In one example, a UE is configured with a serving cell (Cell1) and a non-serving cell (Cell2). A TX power of an SSB of Cell1 is ss-PBCH-Blockpower1, and a TX power of an SSB of Cell2 is ss-PBCH-Blockpower2. From Cell1 and Cell2, a UE measures L1-RSRP of different SSBs as shown in Table 1.

TABLE 1

| Cell1 (serving cell) | Cell2 (non-serving cell) |
|---|---|
| s-SSBRI#1/SS-RSRP-1 | ns-SSBRI#1/SS-RSRP-5 |
| s-SSBRI#2/SS-RSRP-2 | ns-SSBRI#2/SS-RSRP-6 |
| s-SSBRI#3/SS-RSRP-3 | ns-SSBRI#3/SS-RSRP-7 |
| s-SSBRI#3/SS-RSRP-4 | ns-SSBRI#4/SS-RSRP-8 |

In Table 1, s-SSBRI #k/SS-RSRP-k is an index of an L1-RSRP measurement of a k-th SSB from Cell1, and ns-SSBRI #k/SS-RSRP-k is an index of an L1-RSRP measurement of a k-th SSB from Cell2.

In this example, the UE compensates the SS-RSRP of Cell2 as follows:

ns-SS-RSRP-k′=ns-SS-RSRP-k+(ss-PBCH-Blockpowerₛ−ss-PBCH-Blockpowerₙₛ) and use ns-SS-RSRP-k′ in the CSI report. If the UE is configured to report 4 SS-RSRP in a CSI report (e.g., as configured in RRC parameter CSI-ReportConfig), the UE chooses the 4 largest values out of SS-RSRP-1, SS-RSRP-2, SS-RSRP3, SS-RSRP-4, SS-RSRP-5′, SS-RSRP-6′,RSRP-7′, SS-RSRP-8′ to report to the gNB.

In various embodiments, differential reporting may be used. With differential reporting, a SSB with a largest L1-RSRP (e.g., adjusted for an SSB from Cell2 or unadjusted for an SSB from Cell1) is reported in full (e.g., non-differential value) and is used as a reference for the other L1-RSRP reports.

In some embodiments, cell information for each reported SSB may be incorporated in a report. Because an SSB-Index is defined for each cell, the SSB-Index itself may not carry cell information. In certain embodiments, if both the serving cell and at least one non-serving cell are included in the same CSI report, a gNB may need to know whether an SSB is from the serving cell or the at least one non-serving cell. In such embodiments, an SSB index (e.g., SSBRI) may include cell information. Moreover, in such embodiments, cell identification information may be appended before each SSBRI to signal the cell information. The cell identification may have ┌log₂(K)┐ bits, where K is the number of cells (including both serving and non-serving cells) with SSB (or CSI-RS) included in a corresponding CSI-ReportConfig configuration for channel measurement. The cell identification of an SSB may be an order (e.g., counting from 0) in which the cell ID appears in the CSI-ReportConfig IE. In one embodiment, if there is only SSB of one non-serving cell in addition to the serving cell configured in the CSI-ReportConfig IE (e.g., K=2), only 1 bit is required for cell identification. In another embodiment, a cell identification=0 represents a first cell with SSB configured in the CSI-ReportConfig IE for channel measurement. In another embodiment, a cell identification=0 may be used to identify a serving cell, and a cell identification=1 may be used to identify a non-serving cell. In certain embodiments, with a cell identification and an SSB index (e.g., SSBRI), a UE may unambiguously indicate to a gNB a cell and an index of each reported SSB, and a related L1-RSRP value.

In different embodiments described herein, SSB is used as an example such that an RS index is SSBRI and an L1-RSRP value is synchronization signal reference signal received power (“SS-RSRP”). In various embodiments, if CSI-RS is configured for L1-RSRP for inter-cell mobility support, an RS index is CRI (e.g., CSI-RS resource index) instead of SSBRI, and the L1-RSRP is channel state information reference signal received power (“CSI-RSRP”) instead of SS-RSRP. In such embodiment, cell identification bits in the CSI report may be as described in different embodiments herein. Further, in such embodiments, a measured L1-RSRP power of CSI-RS from a non-serving cell may be compensated by a factor (e.g., ss-PBCH-Blockpowerₛ−ss-PBCH-Blockpowerₙₛ) before reporting.

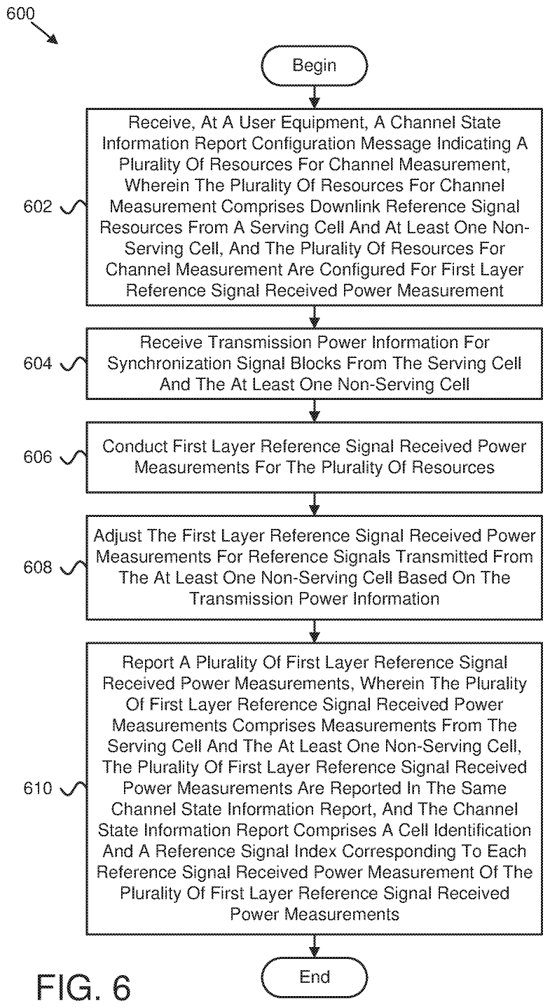

FIG. 6 is a schematic flow chart diagram illustrating one embodiment of a method 600 for reporting reference signal received power for multiple cells. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

The method 600 may include receiving 602, at a user equipment, a channel state information report configuration message indicating a plurality of resources for channel measurement. The plurality of resources for channel measurement includes downlink reference signal resources from a serving cell and at least one non-serving cell, and the plurality of resources for channel measurement are configured for first layer reference signal received power measurement. In various embodiments, the method 600 includes receiving 604 transmission power information for synchronization signal blocks from the serving cell and the at least one non-serving cell. In some embodiments, the method 600 includes conducting 606 first layer reference signal received power measurements for the plurality of resources. In certain embodiments, the method 600 includes adjusting 608 the first layer reference signal received power measurements for reference signals transmitted from the at least one non-serving cell based on the transmission power information. In various embodiments, the method 600 includes reporting 610 a plurality of first layer reference signal received power measurements. As may be appreciated, reporting 610 the plurality of first layer reference signal received power measurements may include reporting only a portion of the first layer reference signal received power measurements actually made. The plurality of first layer reference signal received power measurements includes measurements from the serving cell and the at least one non-serving cell, the plurality of first layer reference signal received power measurements are reported in the same channel state information report, and the channel state information report includes a cell identification and a reference signal index corresponding to each reference signal received power measurement of the plurality of first layer reference signal received power measurements.

In certain embodiments, the first layer reference signal received power measurements of reference signals from the at least one non-serving cell are compensated with a difference between serving cell synchronization signal block transmit power and non-serving cell synchronization signal block transmit power. In some embodiments, the downlink reference signal resources are synchronization signal blocks, the first layer reference signal received power measurements are synchronization signal reference signal received power measurements, and the reference signal index is synchronization signal block rank index, and a report quantity is set to a synchronization signal block index reference signal received power.

In various embodiments, the downlink reference signal resources are channel state information reference signal resources, the first layer reference signal received power measurements are channel state information reference signal received power measurements, the reference signal index in a channel state information reference signal resource indicator, and a report quantity is set to a channel state information reference signal resource indicator reference signal received power. In one embodiment, the cell identification has ┌log₂(K)┐ bits, and K is the number of cells with a downlink reference signal included in a corresponding channel state information report configuration for channel measurement.

In certain embodiments, the cell identification of the serving cell is 0, the at least one non-serving cell comprises only one non-serving cell, and the cell identification of the one non-serving cell is 1. In some embodiments, the cell identification is based on an order of appearance in a corresponding channel state information report configuration for channel measurement. In various embodiments, the transmission power information comprises a non-serving cell synchronization signal block transmit power.

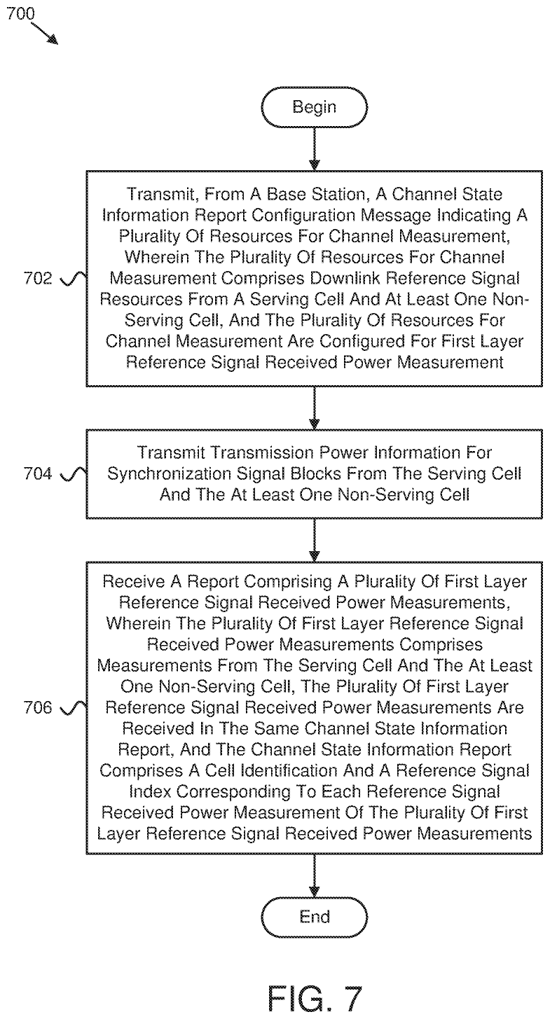

FIG. 7 is a schematic flow chart diagram illustrating another embodiment of a method 700 for reporting reference signal received power for multiple cells. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

The method 700 may include transmitting 702, from a base station, a channel state information report configuration message indicating a plurality of resources for channel measurement. The plurality of resources for channel measurement includes downlink reference signal resources from a serving cell and at least one non-serving cell, and the plurality of resources for channel measurement are configured for first layer reference signal received power measurement. In some embodiments, the method 700 includes transmitting 704 transmission power information for synchronization signal blocks from the serving cell and the at least one non-serving cell. In certain embodiments, the method 700 includes receiving 706 a report including a plurality of first layer reference signal received power measurements. As may be appreciated, receiving 706 the report including the plurality of first layer reference signal received power measurements may include receiving a report of only a portion of the first layer reference signal received power measurements actually made. The plurality of first layer reference signal received power measurements includes measurements from the serving cell and the at least one non-serving cell, the plurality of first layer reference signal received power measurements are received in the same channel state information report, and the channel state information report includes a cell identification and a reference signal index corresponding to each reference signal received power measurement of the plurality of first layer reference signal received power measurements.

In certain embodiments, the first layer reference signal received power measurements of reference signals from the at least one non-serving cell are compensated with a difference between serving cell synchronization signal block transmit power and non-serving cell synchronization signal block transmit power. In some embodiments, the downlink reference signal resources are synchronization signal blocks, the first layer reference signal received power measurements are synchronization signal reference signal received power measurements, and the reference signal index is synchronization signal block rank index, and a report quantity is set to a synchronization signal block index reference signal received power.

In various embodiments, the downlink reference signal resources are channel state information reference signal resources, the first layer reference signal received power measurements are channel state information reference signal received power measurements, the reference signal index in a channel state information reference signal resource indicator, and a report quantity is set to a channel state information reference signal resource indicator reference signal received power. In one embodiment, the cell identification has ┌log₂(K)┐ bits, and K is the number of cells with a downlink reference signal included in a corresponding channel state information report configuration for channel measurement.

In certain embodiments, the cell identification of the serving cell is 0, the at least one non-serving cell comprises only one non-serving cell, and the cell identification of the one non-serving cell is 1. In some embodiments, the cell identification is based on an order of appearance in a corresponding channel state information report configuration for channel measurement. In various embodiments, the transmission power information comprises a non-serving cell synchronization signal block transmit power.

In one embodiment, a method comprises: receiving, at a user equipment, a channel state information report configuration message indicating a plurality of resources for channel measurement, wherein the plurality of resources for channel measurement comprises downlink reference signal resources from a serving cell and at least one non-serving cell, and the plurality of resources for channel measurement are configured for first layer reference signal received power measurement; receiving transmission power information for synchronization signal blocks from the serving cell and the at least one non-serving cell; conducting first layer reference signal received power measurements for the plurality of resources; adjusting the first layer reference signal received power measurements for reference signals transmitted from the at least one non-serving cell based on the transmission power information; and reporting a plurality of first layer reference signal received power measurements, wherein the plurality of first layer reference signal received power measurements comprises measurements from the serving cell and the at least one non-serving cell, the plurality of first layer reference signal received power measurements are reported in the same channel state information report, and the channel state information report comprises a cell identification and a reference signal index corresponding to each reference signal received power measurement of the plurality of first layer reference signal received power measurements.

In certain embodiments, the first layer reference signal received power measurements of reference signals from the at least one non-serving cell are compensated with a difference between serving cell synchronization signal block transmit power and non-serving cell synchronization signal block transmit power.

In some embodiments, the downlink reference signal resources are synchronization signal blocks, the first layer reference signal received power measurements are synchronization signal reference signal received power measurements, and the reference signal index is synchronization signal block rank index, and a report quantity is set to a synchronization signal block index reference signal received power.

In various embodiments, the downlink reference signal resources are channel state information reference signal resources, the first layer reference signal received power measurements are channel state information reference signal received power measurements, the reference signal index in a channel state information reference signal resource indicator, and a report quantity is set to a channel state information reference signal resource indicator reference signal received power.

In one embodiment, the cell identification has ┌log₂(K)┐ bits, and K is the number of cells with a downlink reference signal included in a corresponding channel state information report configuration for channel measurement.

In certain embodiments, the cell identification of the serving cell is 0, the at least one non-serving cell comprises only one non-serving cell, and the cell identification of the one non-serving cell is 1.

In some embodiments, the cell identification is based on an order of appearance in a corresponding channel state information report configuration for channel measurement.

In various embodiments, the transmission power information comprises a non-serving cell synchronization signal block transmit power.

In one embodiment, an apparatus comprises a user equipment. The apparatus further comprises: a receiver that: receives a channel state information report configuration message indicating a plurality of resources for channel measurement, wherein the plurality of resources for channel measurement comprises downlink reference signal resources from a serving cell and at least one non-serving cell, and the plurality of resources for channel measurement are configured for first layer reference signal received power measurement; and receives transmission power information for synchronization signal blocks from the serving cell and the at least one non-serving cell; a processor that: conducts first layer reference signal received power measurements for the plurality of resources; and adjusts the first layer reference signal received power measurements for reference signals transmitted from the at least one non-serving cell based on the transmission power information; and a transmitter that reports a plurality of first layer reference signal received power measurements, wherein the plurality of first layer reference signal received power measurements comprises measurements from the serving cell and the at least one non-serving cell, the plurality of first layer reference signal received power measurements are reported in the same channel state information report, and the channel state information report comprises a cell identification and a reference signal index corresponding to each reference signal received power measurement of the plurality of first layer reference signal received power measurements.

In certain embodiments, the first layer reference signal received power measurements of reference signals from the at least one non-serving cell are compensated with a difference between serving cell synchronization signal block transmit power and non-serving cell synchronization signal block transmit power.

In some embodiments, the downlink reference signal resources are synchronization signal blocks, the first layer reference signal received power measurements are synchronization signal reference signal received power measurements, and the reference signal index is synchronization signal block rank index, and a report quantity is set to a synchronization signal block index reference signal received power.

In various embodiments, the downlink reference signal resources are channel state information reference signal resources, the first layer reference signal received power measurements are channel state information reference signal received power measurements, the reference signal index in a channel state information reference signal resource indicator, and a report quantity is set to a channel state information reference signal resource indicator reference signal received power.

In one embodiment, the cell identification has ┌log₂(K)┐ bits, and K is the number of cells with a downlink reference signal included in a corresponding channel state information report configuration for channel measurement.

In certain embodiments, the cell identification of the serving cell is 0, the at least one non-serving cell comprises only one non-serving cell, and the cell identification of the one non-serving cell is 1.

In some embodiments, the cell identification is based on an order of appearance in a corresponding channel state information report configuration for channel measurement.

In various embodiments, the transmission power information comprises a non-serving cell synchronization signal block transmit power.

In one embodiment, a method comprises: transmitting, from a base station, a channel state information report configuration message indicating a plurality of resources for channel measurement, wherein the plurality of resources for channel measurement comprises downlink reference signal resources from a serving cell and at least one non-serving cell, and the plurality of resources for channel measurement are configured for first layer reference signal received power measurement; transmitting transmission power information for synchronization signal blocks from the serving cell and the at least one non-serving cell; and receiving a report comprising a plurality of first layer reference signal received power measurements, wherein the plurality of first layer reference signal received power measurements comprises measurements from the serving cell and the at least one non-serving cell, the plurality of first layer reference signal received power measurements are received in the same channel state information report, and the channel state information report comprises a cell identification and a reference signal index corresponding to each reference signal received power measurement of the plurality of first layer reference signal received power measurements.

In certain embodiments, the first layer reference signal received power measurements of reference signals from the at least one non-serving cell are compensated with a difference between serving cell synchronization signal block transmit power and non-serving cell synchronization signal block transmit power.

In some embodiments, the downlink reference signal resources are synchronization signal blocks, the first layer reference signal received power measurements are synchronization signal reference signal received power measurements, and the reference signal index is synchronization signal block rank index, and a report quantity is set to a synchronization signal block index reference signal received power.

In various embodiments, the downlink reference signal resources are channel state information reference signal resources, the first layer reference signal received power measurements are channel state information reference signal received power measurements, the reference signal index in a channel state information reference signal resource indicator, and a report quantity is set to a channel state information reference signal resource indicator reference signal received power.

In one embodiment, the cell identification has ┌log₂(K)┐ bits, and K is the number of cells with a downlink reference signal included in a corresponding channel state information report configuration for channel measurement.

In certain embodiments, the cell identification of the serving cell is 0, the at least one non-serving cell comprises only one non-serving cell, and the cell identification of the one non-serving cell is 1.

In some embodiments, the cell identification is based on an order of appearance in a corresponding channel state information report configuration for channel measurement.

In various embodiments, the transmission power information comprises a non-serving cell synchronization signal block transmit power.

In one embodiment, an apparatus comprises a base station. The apparatus further comprises: a transmitter that: transmits a channel state information report configuration message indicating a plurality of resources for channel measurement, wherein the plurality of resources for channel measurement comprises downlink reference signal resources from a serving cell and at least one non-serving cell, and the plurality of resources for channel measurement are configured for first layer reference signal received power measurement; and transmits transmission power information for synchronization signal blocks from the serving cell and the at least one non-serving cell; and a receiver that receives a report comprising a plurality of first layer reference signal received power measurements, wherein the plurality of first layer reference signal received power measurements comprises measurements from the serving cell and the at least one non-serving cell, the plurality of first layer reference signal received power measurements are received in the same channel state information report, and the channel state information report comprises a cell identification and a reference signal index corresponding to each reference signal received power measurement of the plurality of first layer reference signal received power measurements.

In certain embodiments, the first layer reference signal received power measurements of reference signals from the at least one non-serving cell are compensated with a difference between serving cell synchronization signal block transmit power and non-serving cell synchronization signal block transmit power.

In some embodiments, the downlink reference signal resources are synchronization signal blocks, the first layer reference signal received power measurements are synchronization signal reference signal received power measurements, and the reference signal index is synchronization signal block rank index, and a report quantity is set to a synchronization signal block index reference signal received power.

In various embodiments, the downlink reference signal resources are channel state information reference signal resources, the first layer reference signal received power measurements are channel state information reference signal received power measurements, the reference signal index in a channel state information reference signal resource indicator, and a report quantity is set to a channel state information reference signal resource indicator reference signal received power.

In one embodiment, the cell identification has ┌log₂(K)┐ bits, and K is the number of cells with a downlink reference signal included in a corresponding channel state information report configuration for channel measurement.

In certain embodiments, the cell identification of the serving cell is 0, the at least one non-serving cell comprises only one non-serving cell, and the cell identification of the one non-serving cell is 1.

In some embodiments, the cell identification is based on an order of appearance in a corresponding channel state information report configuration for channel measurement.

In various embodiments, the transmission power information comprises a non-serving cell synchronization signal block transmit power.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a user equipment (UE), the method comprising:
receiving, at a UE, a channel state information (CSI) report configuration message indicating a plurality of resources for channel measurement, wherein the plurality of resources for channel measurement comprises downlink reference signal (RS) resources from a serving cell and at least one non-serving cell, and the plurality of resources for channel measurement are configured for first layer RS received power measurement;
receiving transmission power information for synchronization signal blocks (SSBs) from the serving cell and the at least one non-serving cell;
conducting first layer RS received power measurements for the plurality of resources;
adjusting the first layer RS received power measurements for RSs transmitted from the at least one non-serving cell based on the transmission power information; and
reporting a plurality of first layer RS received power measurements, wherein the plurality of first layer RS received power measurements comprises measurements from the serving cell and the at least one non-serving cell, the plurality of first layer RS received power measurements are reported in the same CSI report, and the CSI report comprises a cell identification (ID) and a RS index corresponding to each RS received power measurement of the plurality of first layer RS received power measurements.

2. The method of claim 1, wherein the first layer RS received power measurements of RSs from the at least one non-serving cell are compensated with a difference between serving cell SSB transmit power and non-serving cell SSB transmit power.

3. The method of claim 1, wherein the downlink RS resources are SSBs, the first layer RS received power measurements are synchronization signal RS received power measurements, and the RS index is SSB rank index, and a report quantity is set to a SSB index RS received power.

4. The method of claim 1, wherein the downlink RS resources are CSI-RS resources, the first layer RS received power measurements are CSI-RS received power measurements, the RS index in a CSI-RS resource indicator, and a report quantity is set to a CSI-RS resource indicator RS received power.

5. The method of claim 1, wherein the cell ID has ┌log₂(K)┐ts, and K is a number of cells with a downlink RS included in a corresponding CSI report configuration for channel measurement.

6. The method of claim 1, wherein the cell ID of the serving cell is 0, the at least one non-serving cell comprises only one non-serving cell, and the cell ID of the one non-serving cell is 1.

7. The method of claim 1, wherein the cell ID is based on an order of appearance in a corresponding CSI report configuration for channel measurement.

8. The method of claim 1, wherein the transmission power information comprises a non-serving cell SSB transmit power.

9. A user equipment (UE), comprising:
at least one memory; and
at least one processor coupled with the at least one memory and configured to cause the UE to:
receive a channel state information (CSI) report configuration message indicating a plurality of resources for channel measurement, wherein the plurality of resources for channel measurement comprises downlink reference signal (RS) resources from a serving cell and at least one non-serving cell, and the plurality of resources for channel measurement are configured for first layer RS received power measurement;
receive transmission power information for synchronization signal blocks (SSBs) from the serving cell and the at least one non-serving cell;
conduct first layer RS received power measurements for the plurality of resources;
adjust the first layer RS received power measurements for RSs transmitted from the at least one non-serving cell based on the transmission power information; and
report a plurality of first layer RS received power measurements, wherein the plurality of first layer RS received power measurements comprises measurements from the serving cell and the at least one non-serving cell, the plurality of first layer RS received power measurements are reported in the same CSI report, and the CSI report comprises a cell identification (ID) and a RS index corresponding to each RS received power measurement of the plurality of first layer RS received power measurements.

10. A base station, comprising:
at least one memory; and
at least one processor coupled with the at least one memory and configured to cause the base station to:
transmit a channel state information (CSI) report configuration message indicating a plurality of resources for channel measurement, wherein the plurality of resources for channel measurement comprises downlink reference signal (RS) resources from a serving cell and at least one non-serving cell, and the plurality of resources for channel measurement are configured for first layer RS received power measurement;
transmit transmission power information for synchronization signal blocks (SSBs) from the serving cell and the at least one non-serving cell; and
receive a report comprising a plurality of first layer RS received power measurements, wherein the plurality of first layer RS received power measurements comprises measurements from the serving cell and the at least one non-serving cell, the plurality of first layer RS received power measurements are received in the same CSI report, and the CSI report comprises a cell identification (ID) and a RS index corresponding to each RS received power measurement of the plurality of first layer RS received power measurements.

11. The base station of claim 10, wherein the first layer RS received power measurements of RSs from the at least one non-serving cell are compensated with a difference between serving cell SSB transmit power and non-serving cell SSB transmit power.

12. The base station of claim 10, wherein the downlink RS resources are SSBs, the first layer RS received power measurements are synchronization signal RS received power measurements, and the RS index is SSB rank index, and a report quantity is set to a SSB index RS received power.

13. The base station of claim 10, wherein the downlink RS resources are CSI-RS resources, the first layer RS received power measurements are CSI-RS received power measurements, the RS index in a CSI-RS resource indicator, and a report quantity is set to a CSI-RS resource indicator RS received power.

14. The base station of claim 10, wherein:
the cell ID has ┌log₂(K)┐ts, and K is a number of cells with a downlink RS included in a corresponding CSI report configuration for channel measurement;
the cell ID of the serving cell is 0, the at least one non-serving cell comprises only one non-serving cell, and the cell ID of the one non-serving cell is 1;
the cell ID is based on an order of appearance in a corresponding CSI report configuration for channel measurement;
the transmission power information comprises a non-serving cell SSB transmit power;
or a combination thereof.

15. (canceled)

16. A processor for wireless communication, comprising:
at least one controller coupled with at least one memory and configured to cause the processor to:
receive, at a user equipment (UE), a channel state information (CSI) report configuration message indicating a plurality of resources for channel measurement, wherein the plurality of resources for channel measurement comprises downlink reference signal (RS) resources from a serving cell and at least one non-serving cell, and the plurality of resources for channel measurement are configured for first layer RS received power measurement;
receive transmission power information for SSBs from the serving cell and the at least one non-serving cell;
conduct first layer RS received power measurements for the plurality of resources;
adjust the first layer RS received power measurements for RSs transmitted from the at least one non-serving cell based on the transmission power information; and
report a plurality of first layer RS received power measurements, wherein the plurality of first layer RS received power measurements comprises measurements from the serving cell and the at least one non-serving cell, the plurality of first layer RS received power measurements are reported in the same CSI report, and the CSI report comprises a cell identification (ID) and a RS index corresponding to each RS received power measurement of the plurality of first layer RS received power measurements.

17. The UE of claim 9, wherein the first layer RS received power measurements of RSs from the at least one non-serving cell are compensated with a difference between serving cell SSB transmit power and non-serving cell SSB transmit power.

18. The processor of claim 16, wherein the downlink RS resources are SSBs, the first layer RS received power measurements are synchronization signal RS received power measurements, and the RS index is SSB rank index, and a report quantity is set to a SSB index RS received power.

19. The processor of claim 16, wherein the downlink RS resources are CSI-RS resources, the first layer RS received power measurements are CSI-RS received power measurements, the RS index in a CSI-RS resource indicator, and a report quantity is set to a CSI-RS resource indicator RS received power.

20. The processor of claim 16, wherein the cell ID has ┌log₂(K)┐ts, and K is a number of cells with a downlink RS included in a corresponding CSI report configuration for channel measurement.

21. The processor of claim 16, wherein the cell ID of the serving cell is 0, the at least one non-serving cell comprises only one non-serving cell, and the cell ID of the one non-serving cell is 1.
